(19) United States
(12) Patent Application Publication
(10) Pub. No.: US 2011/0044355 A1
(43) Pub. Date: Feb. 24, 2011

(54) APPARATUS AND METHOD FOR RESTORING NETWORK CLOCK REFERENCE OF TRANSMISSION DATA, AND DATA RECEIVING APPARATUS

(75) Inventors: Nam-kyung Lee, Daejeon-si (KR); Ki-seop Han, Gyeonggi-do (KR); Dae-ig Chang, Daejeon-si (KR); Ho-jin Lee, Daejeon-si (KR)

Correspondence Address: NELSON MULLINS RILEY & SCARBOROUGH LLP;FLOOR 30, SUITE 3000, ONE POST OFFICE SQUARE, BOSTON, MA, 02109, US

(73) Assignee: Electronics and Telecommunications Research Institute, Daejeon-si (KR)

(21) Appl. No.: 12/812,991

(22) PCT Filed: Sep. 11, 2009
(86) PCT No.: PCT/KR09/05196

§ 371 Date: Jul. 15, 2010

(30) Foreign Application Priority Data
Sep. 23, 2008 (KR) 10-2008-0093358

(51) Int. Cl. H04J 3/24

(52) U.S. Cl. 370/474

(57) ABSTRACT

A method of reconstructing reference time information of a transmission frame in a digital satellite communication system is provided, including: receiving the transmission frame including reference time information; recording receiving time of start of frames of the plurality of physical layer frames included in the transmission frame; determining receiving time of a start of frame corresponding to the physical layer frames including the reference time information based on the recorded information when the physical layer frame including the reference time information is received; and reconstructing the reference time information based on the determined receiving time information of the start of frame. Network synchronization is stably acquired and maintained during two-way communication even in the satellite communication network environment.

### TECHNICAL FIELD

The present invention relates to a digital satellite communication system, and more particularly, to a method of reconstructing reference time information of a transmission frame in a digital satellite communication system.

### BACKGROUND ART

High-speed two-way satellite communication systems using a satellite network employ a digital video broadcasting satellite (DVB-S) technique based on time division multiplexing (TDM) in a forward link, and a digital video broadcasting with return channel via satellite (DVB-RCS) technique based on time division multiple access (TDMA) in a reverse link. In such satellite broadcasting and communication systems, in order to reconstruct a clock of a receiving side, program clock reference (PCR) information generated using a reference clock of a hub station is included in a moving picture experts group 2 transport stream (MPEG2-TS) having a certain program ID (PID) and is periodically transmitted.

The receiving side reconstructs a reference clock of the hub station using the received PCR value and a PCR cycle, and uses the reconstructed reference clock as its reference clock. In such a satellite communication system, a value included in a PCR field of the MPEG standard for clock and timing synchronization of the reverse link is referred to as a network clock reference (NCR).

A DVB-S2-based data transmission technique which is suggested as a next generation DVB standard is specified to support a variable length packet transmission technique which is also called generic stream encapsulation. When a transmitting end of a satellite communication system of a DVB-S2 standard transmits NCRs at an arbitrary interval, several physical layer frames (PL-frames) of different lengths are transmitted in the case of variable and adaptive channel coding/modulations (VCM/ACM). Therefore, there is a limitation in that reference time information, that is, an NCR, cannot be transmitted at an accurately regular interval. That is, there is a difficulty in finding accurate receiving time of a start of frame (SOF) (hereinafter, SOF receiving time or receiving time of a start of frame).

### DISCLOSURE OF INVENTION

### Technical Problem

The present invention provides a method and apparatus for reconstructing reference time information in which receiving time information of a start of frame within a transmission frame and reference time information are accurately mapped with each other.

### Technical Solution

According to an exemplary aspect, there is provided a method of reconstructing reference time information of a transmission frame including a plurality of physical layer frames in a digital satellite communication system of a variable length packet transmission method, including receiving the transmission frame including reference time information, recording receiving time of a start of frame of the physical layer frames included in the transmission frame, determining receiving time of a start of frame corresponding to the physical layer frame including the reference time information based on the recorded information when the physical layer frame including the reference time information is received, and reconstructing the reference time information based on the determined receiving time information of the start of frame.

The determining of the receiving time of the start of frame may include calculating a reference time information receiving time difference between receiving time of the received reference time information and receiving time of a previous reference time information when the physical layer frame including the reference time information is received, and determining receiving time of a start of frame corresponding to the input reference time information based on the computed reference time information receiving time difference and receiving time information of a start of frame corresponding to the previous reference time information.

According to another exemplary aspect, there is provided an apparatus for reconstructing reference time information of a transmission frame in a digital satellite communication system of a variable length packet transmission method, including a receiving time recorder recording receiving time of start of frames of a plurality of physical layer frames included in the transmission frame when the transmission frame including reference time information is received, a receiving time determiner determining receiving time of a start of frame corresponding to the received reference time information based on information recorded by the receiving time recorder when the physical layer frame including the reference time information is received, and a reconstruction unit reconstructing the reference time information based on the determined receiving time information of the start of frame.

According to still another exemplary aspect, there is provided a data receiving apparatus for a digital satellite communication system of a variable length packet transmission method, including a receiving time recorder recording receiving time of start of frames of a plurality of physical layer frames included in a transmission frame when the transmission frame including reference time information is received from a data transmission apparatus, a receiving time determiner determining receiving time of a start of frame corresponding to the physical layer frame including the reference time information based on information recorded by the receiving time recorder when the physical layer frame including the reference time information is received, a reconstruction unit reconstructing the reference time information based on the determined receiving time information of the start of frame, and a synchronizer performing synchronization to synchronize data communication with the data transmission apparatus based on the reference time information reconstructed by the reconstruction unit.

Additional features of the invention will be set forth in the description which follows, and in part will be apparent from the description, or may be learned by practice of the invention.

### ADVANTAGEOUS EFFECTS

According to an exemplary embodiment, NCR information necessary for acquiring and maintaining network synchronization in the satellite communication environment using a GSE method can be transmitted, and the NCR information is mapped with receiving time information of a start of frame and reconstructed, so that two-way communication is possible even in the satellite communication environment. In addition, since discordance between transmitting time and receiving time is solved and an accurate value is reconstructed, network synchronization is stably acquired and maintained.

### BRIEF DESCRIPTION OF DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram of a data receiving apparatus including a reference time information reconstruction apparatus according to an exemplary embodiment;

FIGS. 2 to 4 are views illustrating a process of computing receiving time of a start of frame of a physical layer frame including reference time information according to an exemplary embodiment; and

FIG. 5 is a flowchart illustrating a method of reconstructing reference time information of a transmission frame according to an exemplary embodiment.

### MODE FOR THE INVENTION

The invention is described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the sizes and relative sizes of layers and regions may be exaggerated for clarity. Like reference numerals in the drawings denote like elements.

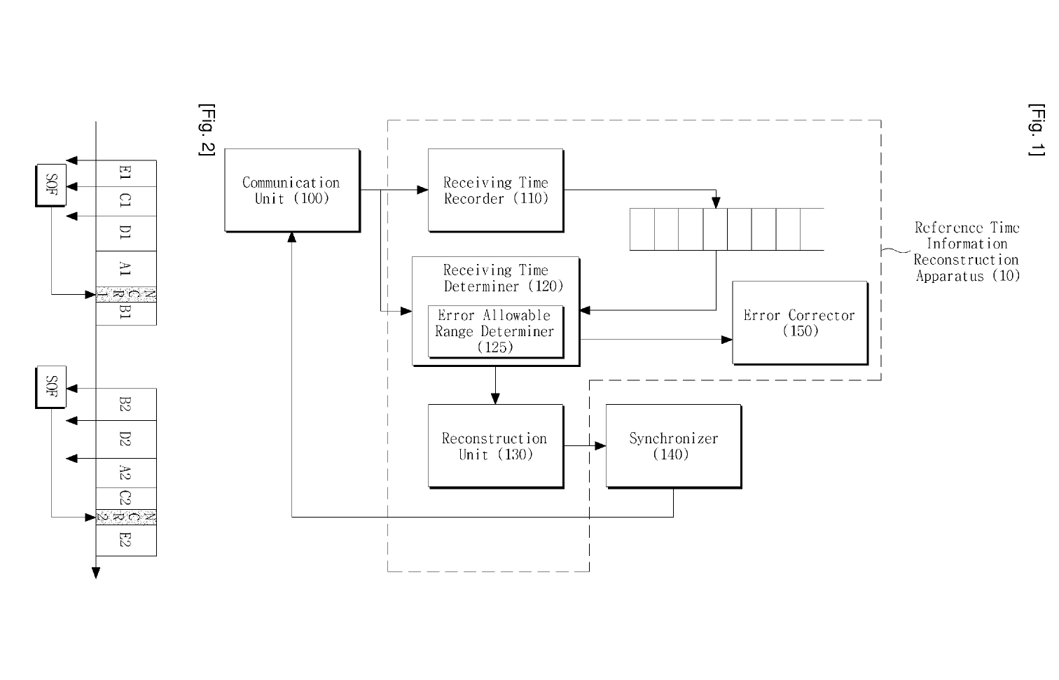

FIG. 1 is a block diagram of a data receiving apparatus including a reference time information reconstruction apparatus according to an exemplary embodiment.

As shown in FIG. 1, the reference time information reconstruction apparatus 10 includes a receiving time recorder 110, a receiving time determiner 120, and a reconstruction unit 130.

A communication unit 100 receives a transmission stream transmitted from an external data transmission apparatus. The transmission stream may be data of a DVB-S2 frame type acquired from a data transmission apparatus such as a hub station. In one embodiment, when a start-of-frame (SOF) is generated by a DVB-S2 modulator of a data transmission apparatus, an NCR value is extracted, and physical layer frames including an NCR value are generated. The physical layer frames are included in a DVB-S2 frame to generate a transmission stream.

The receiving time recorder 110 records receiving time of a start of frame of the physical layer frames which are included in a transmission frame received through the communication unit 100. At this time, receiving time of a start of frame is recorded in a receiving window. SOF input time values recorded in the receiving window are relayed sequentially in time.

The physical layer frame is transmitted such that a forward error correction (FEC) frame block is divided into small unit slots of tens of symbols as a frame process for real transmission through modulation. The physical layer frame includes a start-of-frame (SOF), which is starting point information of each frame, signaling information of modulation coding (MODCOD) for informing of a transmission method, and a pilot signal for carrier reconstruction if necessary.

In a typical radio communication system, due to the poor radio channel environment, movement of a mobile station, and an error between an oscillator of a mobile station and an oscillator of a base station, when a burst is received, it is difficult for a data receiving apparatus to drive or stop a radio frequency (RF) circuit and components thereof at an accurate point in time. For this reason, a data receiving apparatus receives a burst with a time margin before and after a burst to be received, and then extracts and processes a desired section. A receiving window refers to a section in which a data receiving apparatus operates communication circuits such as a RF circuit to receive a burst signal.

The receiving time determiner 120 determines receiving time of a start of frame corresponding to a physical layer frame including reference time information when the reference time information is included in a transmission frame received through the communication unit 100.

In detail, when reference time information is received, the receiving time determiner 120 first determines time information in which previous reference time information is received and receiving time information of a start of frame of a physical layer frame including the previous reference time information. At this time, the previous reference time information and the receiving time information of a start of frame may be determined using information which is previously stored.

Then, the receiving time determiner 120 computes a reference time information receiving time difference between time when reference time information is received and time when previous reference time information is received. The receiving time determiner 120 may determine receiving time information of a start of frame of a physical layer frame including received reference time information based on the reference time information receiving time difference and receiving time information of a start of frame of a physical layer frame including the previous reference time information.

The receiving time determiner 120 may further include an error allowable range determiner 125. The error allowable range determiner 125 determines whether or not a reference time information receiving time difference between a difference between time when reference time information is received and time when the previous reference time information is received and a SOF receiving time difference between SOF receiving time corresponding to the previous reference time information and SOF receiving time corresponding to the received reference time information has a value within an error allowable range. An error corrector 150 corrects an error occurring during data transmission when it is determined by the error allowable range determiner 125 that it has a value which exceeds an error allowable range, thereby further improving data transmission efficiency.

That is, according to an exemplary embodiment, there is an effect of being capable of accurately mapping reference time information with time information in which a SOF of a physical layer frame including the reference time information is received.

The reconstruction unit 130 reconstructs the received reference time information using receiving time information of a start of frame of a physical layer frame including the received reference time information and determines reference time information. In detail, the reconstruction unit 130 may reconstruct a 27 MHz reference clock of a hub station, which is a data transmitting device, using time when reference time information is received and NCR values which are sequentially transmitted.

A data receiving apparatus according to an exemplary embodiment includes the reference time information reconstruction apparatus according to an exemplary embodiment, a communication unit 100 and a synchronizer 140. In the present embodiment, the communication unit 100 receives a transmission frame from a data transmission apparatus according to the DVB-S2 standard.

The synchronizer 140 performs synchronization with a data transmission apparatus which transmits a transmission frame received through the communication unit 100 based on the determined reference time information. Therefore, there is an effect of being capable of performing two-way communication with a data transmission apparatus. The synchronizer 140 computes a time difference value between a SOF flag and a NCR flag based on given information to reconstruct a reference clock of a data transmission apparatus, for example, a 27 MHz clock, and acquire current time information of the data receiving apparatus. The synchronizer 140 may accurately determine time when reference time information is actually received to perform reverse link transmission. That is, it is possible to reconstruct a reference clock of a hub station and stably acquire and maintain time information when reference time information is actually received.

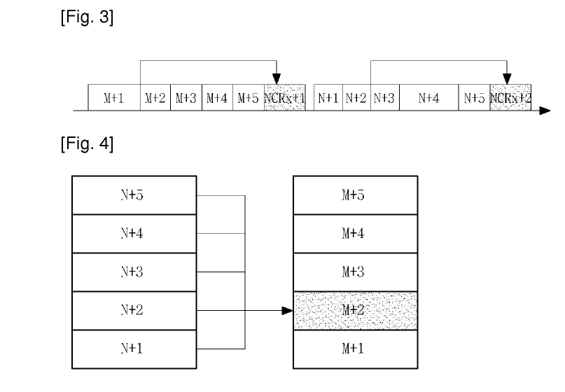

FIGS. 2 to 4 are views for describing a process of computing receiving time of a start of frame of a physical layer frame including reference time information according to an exemplary embodiment.

As described above, a data transmission apparatus of a satellite communication system according to the DVB-S2 standard transmits reference time information at an arbitrary interval. When adaptive coding and modulation (ACM) or variable coding and modulation (VCM) is applied, a transmission frame including physical layer frames of different lengths is transmitted, and thus it is difficult to insert reference time information at an accurately regular interval. For this problem, in order to transmit reference time information, SOF time information at a point in time at which a SOF of a physical layer frame is transmitted is inserted and transmitted as reference time information.

However, since lengths of physical layer frames transmitted are different depending on a structure of a transmitter, a location in which reference time information is inserted in a transmission frame is not identical. Therefore, a data receiving apparatus which receives a transmission frame including physical layer frames needs to perform a function of determining to which physical layer frame SOF time information received as reference time information pertains.

For example, as shown in FIG. 2, NCR1 is a value corresponding to SOF transmission time of a physical layer frame C1, and NCR2 is a value corresponding to SOF transmission time of a physical layer frame B2. However, as can be seen from FIG. 2, NCR1 is inserted in a third physical layer frame after the physical layer frame C1, and NCR2 is inserted in a fourth physical layer frame after the physical layer frame B2. Therefore, a location in which reference time information, that is, NCR, is inserted is different according to a structure of a data transmission apparatus, that is, a transmitter. In order to overcome the problem, a data receiving apparatus which receives a transmission frame needs to accurately map received reference time information with a location of a SOF corresponding thereto.

For ease of description, it is assumed that transmission frames are received as shown in FIG. 3, NCRx+1 is SOF transmission time of a physical layer frame M+2, and NCRx+2 is SOF transmission time of a physical layer frame N+3.

First, when NCRx+2 is received, the receiving time determiner 120 according to an exemplary embodiment determines NCRx+1 which is previously received. At this time, the receiving time determiner 120 determines SOF receiving time “M+2” corresponding to NCRx+1 among values recorded in a receiving window. As shown in FIG. 4, receiving time of a start of frame of physical layer frames before NCRx+2 is received are subtracted. That is, values of (N+5)−(M+2), (N+4)−(M+2), and (N+3)−(M+2) are sequentially computed. Receiving time of a start of frame, which is identical to a computation result value “NCRx+2—NCRx+1” is found.

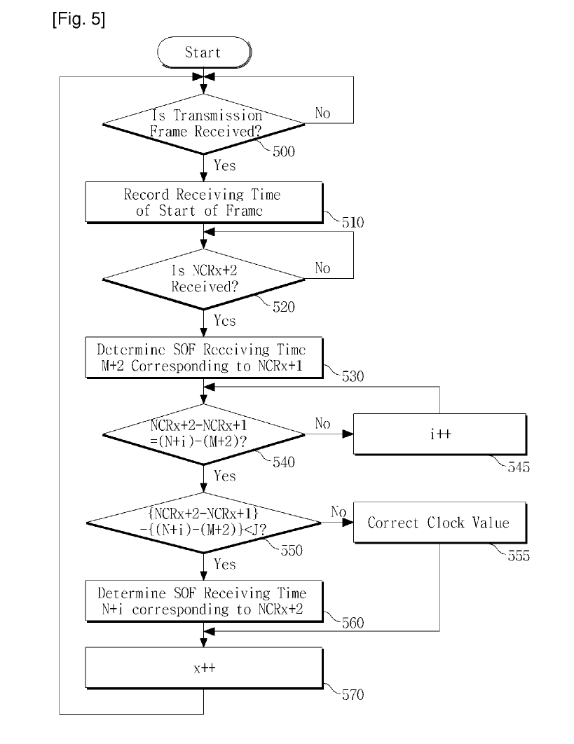

FIG. 5 is a flowchart illustrating a method of reconstructing reference time information of a transmission frame according to an exemplary embodiment.

First, when a transmission frame is received (500), a SOF receiving time value included in the transmission frame is recorded (510). Then, when reference time information, that is, NCRx+2, is received (520), reference time information NCRx+1, which is previously received, is determined.

Then, SOF receiving time M+2 corresponding to the previous reference time information NCRx+1 is determined (530). An Ni value in which a value of ‘NCRx+2−NCRx+1’ becomes identical to a value of (N+i)−(M+2) is found while sequentially increasing an i value.

At this time, it is additionally determined whether or not a value of “{NCRx+2−NCRx+1}−{(N+i)−(M+2)}” is smaller than a predetermined value J. The predetermined value J is an error allowable range for an error occurring during data transmission.

When it is determined that the value of “{NCRx+2—NCRx+1}−{(N+i)−(M+2)}” is larger than the predetermined value J, in order to correct an error occurring during data transmission, a clock value is corrected (555), whereby data transmission efficiency is more improved.

Here, an Ni value in which a value of “NCRx+2−NCRx+1” becomes identical to a value of “(N+i)−(M+2)” is SOF receiving time corresponding to received reference time information NCRx+2 (560). SOF receiving time corresponding to reference time information included in transmission frames which are continuously received may be determined while increasing an x value (570).

The reference time information reconstruction method described above may be implemented as a computer program. The computer program may be stored in a computer-readable recording medium, and read and executed by a computer to perform the above-described functions. Examples of the computer-readable recording medium include a magnetic recording medium and an optical recording medium.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. A method of reconstructing reference time information of a transmission frame including a plurality of physical layer frames in a digital satellite communication system of a variable length packet transmission method, comprising:
receiving the transmission frame including reference time information;
recording receiving time of a start of frame of the physical layer frames included in the transmission frame;
determining receiving time of a start of frame corresponding to the physical layer frame including the reference time information based on the recorded information when the physical layer frame including the reference time information is received; and
reconstructing the reference time information based on the determined receiving time information of the start of frame.

2. The method of claim 1, wherein, in recording the receiving time of the start of frame, the receiving time information of the start of frame is sequentially recorded in a receiving window.

3. The method of claim 2, wherein, in recording the receiving time of the start of frame, the receiving time information of the start of frame recorded in a receiving window of a predetermined size is relayed according to an input sequence.

4. The method of claim 1, wherein the determining of the receiving time of the start of frame comprises:
calculating a reference time information receiving time difference between receiving time of the received reference time information and receiving time of a previous reference time information when the physical layer frame including the reference time information is received; and
determining receiving time of a start of frame corresponding to the input reference time information based on the computed reference time information receiving time difference and receiving time information of a start of frame corresponding to the previous reference time information.

5. The method of claim 4, wherein receiving time information of a start of frame corresponding to the received reference time information is determined such that the calculated reference time information receiving time difference can be identical with a difference between the receiving time information of the start of frame corresponding to the previous reference time information and the receiving time information of the start of frame corresponding to the received reference time information.

6. The method of claim 5, wherein the determining of the receiving time of the start of frame comprises:
determining whether or not a difference between the reference time information receiving time difference and the receiving time difference between start of frames has a value within an error allowable range; and
determining receiving time of a start of frame corresponding to the received reference time information when it is determined that the difference has a value within the error allowable range.

7. The method of claim 6, wherein the determining of the receiving time of the start of frame further comprises performing an error correction when it is determined that the difference has a value which exceeds the error allowable range.

8. An apparatus for reconstructing reference time information of a transmission frame in a digital satellite communication system of a variable length packet transmission method, comprising:
a receiving time recorder recording receiving time of start of frames of a plurality of physical layer frames included in the transmission frame when the transmission frame including reference time information is received;
a receiving time determiner determining receiving time of a start of frame corresponding to the received reference time information based on information recorded by the receiving time recorder when the physical layer frame including the reference time information is received; and
a reconstruction unit reconstructing the reference time information based on the determined receiving time information of the start of frame.

9. The apparatus of claim 8, wherein the receiving time recorder sequentially records the receiving time information of the start of frame in a receiving window.

10. The apparatus of claim 9, wherein the receiving time recorder records the receiving time information of the start of frame so that the receiving time information of the start of frame recorded in a receiving window of a predetermined size is relayed according to an input sequence.

11. The apparatus of claim 8, wherein the receiving time determiner computes a reference time information receiving time difference between receiving time of the received reference time information and receiving time of a previous reference time information when the physical layer frame including the reference time information is received, and determines the start-of-frame corresponding to the reference time information based on the computed reference time information receiving time difference and receiving time information of a start of frame corresponding to the previously input reference time information.

12. The apparatus of claim 11, wherein the receiving time determiner determines receiving time information of a start of frame corresponding to the received reference time information such that the calculated reference time information receiving time difference can be identical with a difference between the receiving time information of a start of frame corresponding to the previous reference time information and the receiving time information of a start of frame corresponding to the received reference time information.

13. The apparatus of claim 12, wherein the receiving time determiner comprises an error allowable range determiner determining whether or not a difference between the reference time information receiving time difference and the receiving time difference between start of frames has a value within an error allowable range and determines receiving time of a start of frame corresponding to the received reference time information when it is determined by the error allowable range determiner that the difference has a value within the error allowable range.

14. The apparatus of claim 13, further comprising an error corrector performing an error correction when it is determined by the error allowable range determiner that the difference has a value which exceeds the error allowable range.

15. A data receiving apparatus for a digital satellite communication system of a variable length packet transmission method, comprising:
a receiving time recorder recording receiving time of start of frames of a plurality of physical layer frames included in a transmission frame when the transmission frame including reference time information is received from a data transmission apparatus;
a receiving time determiner determining receiving time of a start of frame corresponding to the physical layer frame including the reference time information based on information recorded by the receiving time recorder when the physical layer frame including the reference time information is received;
a reconstruction unit reconstructing the reference time information based on the determined receiving time information of the start of frame; and
a synchronizer performing synchronization to synchronize data communication with the data transmission apparatus based on the reference time information reconstructed by the reconstruction unit.
